(19) United States
(12) Patent Application Publication
(10) Pub. No.: US 2011/0056602 A1
(43) Pub. Date: Mar. 10, 2011

(54) RIGID AIR VALVE

(76) Inventors: Mark Thomas, Sault Ste. Marie (CA); Donald Trottier, Sault Ste. Marie (CA); Brent Tarini, Sudbury (CA)

(21) Appl. No.: 12/631,399

(22) Filed: Dec. 4, 2009

Related U.S. Application Data
(60) Provisional application No. 61/240,375, filed on Sep. 8, 2009.

(51) Int. Cl. B60C 29/02; B23P 17/00

(52) U.S. Cl. 152/427; 137/15.18

(57) ABSTRACT

A rigid air valve comprises a valve body and a valve stem. The valve body has a shoulder for abutting an inner cylindrical surface of the wheel. A first protruding portion extends radially outwardly from the shoulder into a valve hole. The first protruding portion extends to a tire-side surface of the wheel. A second protruding portion extends both radially inwardly and axially outwardly through a hole in a center plate of the wheel to thereby define a curved air passageway extending from a first opening in the first protruding portion to a second opening in the second protruding portion. The valve stem has external threads for engaging complementary internal threads inside the second protruding portion. The valve stem includes a valve for selectively admitting air into a tire when mounted on the wheel. This valve is robust and durable, reduces inflation time and eliminates leaky spuds and O-rings.

### CROSS-REFERENCE TO RELATED APPLICATIONS

This application claims priority under 35 USC 119(e) from U.S. Provisional Patent Application 61/240,375 filed Sep. 8, 2009.

### TECHNICAL FIELD

The present technology relates generally to air valves and, in particular, to air valves for tubeless tires.

### BACKGROUND

FIG. 1 depicts an example of an industry-standard prior-art air valve. This air valve, generally designated by reference numeral 2, is designed to be installed on wheel (rim) that is adapted to receive a tubeless pneumatic tire. This prior-art valve has a spud 4 for connecting the valve to a valve hole (rim hole) in the wheel. The spud employs an O-ring or rubber seal 6 to provide an airtight seal at interface of the valve and valve hole. However, it has been found that the conventional valve technology is deficient in a number of respects. Firstly, the spud and O-ring (or other seal) is prone to leakage. Secondly, the curved and slender brass extension 8 that supports the valve 10 has been found to be vulnerable to damage and failure. The brass extension is particularly vulnerable to damage when the wheel is lifted for mounting on a hub. If the valve is damaged, a slow leak may result which may ultimately lead to costly tire damage and downtime.

### SUMMARY

In general, the present invention provides a rigid air valve has a first protruding portion that fits directly into the valve hole and a second protruding portion in which a valve stem is threaded. The valve body may be made of one single integral piece with an air passageway formed from a first opening in the first protruding portion to a second opening in the second protruding portion. The first protruding portion can be welded into the valve hole. This rigid air valve overcomes, or at least partially mitigates, some of the deficiencies and disadvantages of the prior-art valves. This novel air valve has no valve spud, O-ring or rubber seal at the connection or interface between the valve and the valve hole. Accordingly, this novel valve is far less prone to leakage and is, moreover, easier to assemble to a wheel than the prior-art valves. This novel air valve furthermore has a construction that is significantly more robust than the prior-art valves whose slender brass extensions are vulnerable to damage and failure. Furthermore, the revolutionary new structure of the rigid air valve permits a significantly wider air passageway to deliver air more rapidly to the tire, thus diminishing inflation time.

Thus, a main aspect of the present invention is a rigid air valve for use with a wheel. The valve comprises a valve body and a valve stem. The valve body has a shoulder for abutting an inner cylindrical surface of the wheel, a first protruding portion extending radially outwardly from the shoulder and sized to be snugly inserted into a valve hole until the shoulder abuts the inner cylindrical surface of the wheel, the first protruding portion extending from the inner cylindrical surface of the wheel to a tire-side outer cylindrical surface of the wheel, and a second protruding portion extending both radially inwardly and axially outwardly through a hole in a center plate of the wheel to thereby define a curved air passageway extending from a first opening in the first protruding portion to a second opening in the second protruding portion. The valve stem has external threads for engaging complementary internal threads inside the second protruding portion. The valve stem includes a valve for selectively admitting air into a pneumatic tire when mounted on the wheel.

Another aspect of the present invention is a method of installing an air valve onto a wheel. The method comprises inserting the valve body into the valve hole, tack-welding the valve body on the inner cylindrical surface of the wheel, welding the valve body on a tire-side outer cylindrical surface of the wheel by filling a counterbore with weld, grinding the weld flush with the tire-side outer cylindrical surface of the wheel, and connecting a valve stem having a valve to the valve body.

Yet another aspect of the present invention is a wheel-valve assembly. The wheel-valve assembly has a wheel adapted for receiving a tubeless tire and a rigid air valve that comprises a valve body and a valve stem. The valve body has a shoulder for abutting an inner cylindrical surface of the wheel, a first protruding portion extending radially outwardly from the shoulder and sized to be snugly inserted into a valve hole until the shoulder abuts the inner cylindrical surface of the wheel, the first protruding portion extending from the inner cylindrical surface of the wheel to a tire-side outer cylindrical surface of the wheel, and a second protruding portion extending both radially inwardly and axially outwardly through a hole in a center plate of the wheel to thereby define a curved air passageway extending from a first opening in the first protruding portion to a second opening in the second protruding portion. The valve stem has external threads for engaging complementary internal threads formed in the second opening, the valve stem including a valve for selectively admitting air into a pneumatic tire when mounted on the wheel.

The details and particulars of these aspects of the invention will now be described below, by way of example, with reference to the attached drawings.

### BRIEF DESCRIPTION OF THE DRAWINGS

Further features and advantages of the present technology will become apparent from the following detailed description, taken in combination with the appended drawings, in which:

FIG. 1 is a side view of a prior-art air valve having a valve spud and rubber seal;

FIG. 2 is an side view of a novel rigid air valve in accordance with one embodiment of the present invention;

FIG. 3 is a cross-sectional view of the rigid air valve of FIG. 2 installed in a wheel prior to installation of a tubeless tire on the wheel;

FIG. 4 is an isometric view of the wheel-valve assembly shown in FIG. 3; and

FIG. 5 is an isometric view of a valve body of a rigid air valve in accordance with one embodiment of the present invention;

FIG. 6 is a frontal view of the valve body of FIG. 5;

FIG. 7 is a top plan view of the valve body of FIG. 5;

FIG. 8 is a cross-sectional view of the valve body, taken through section A-A of FIG. 7;

FIG. 9 is a cross-sectional view of the valve body, taken through section B-B of FIG. 7; and

FIG. 10 is an enlarged cross-sectional view of the valve installed within a wheel.

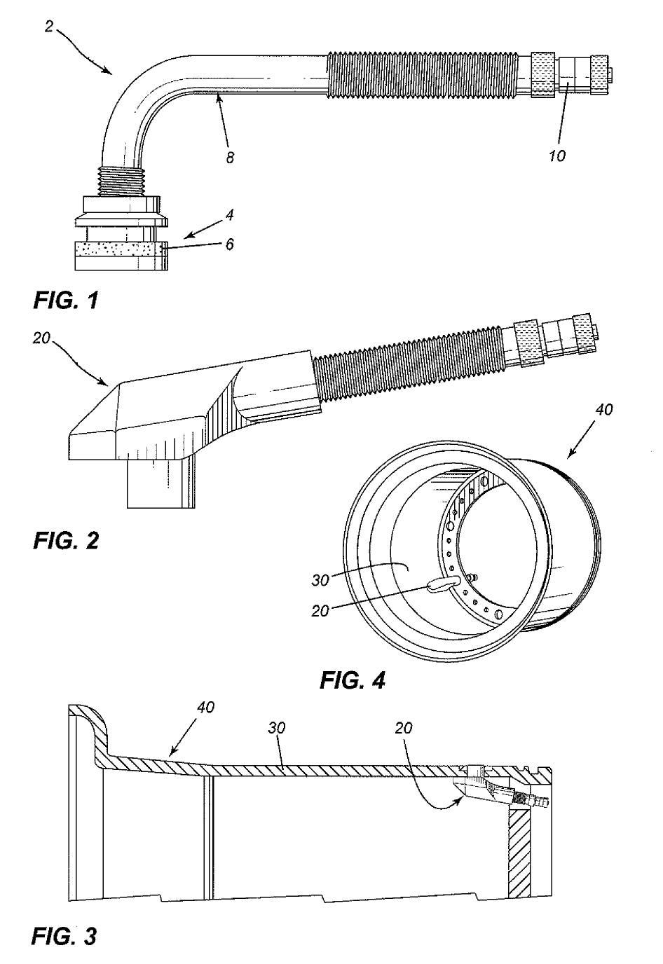

It will be noted that throughout the appended drawings, like features are identified by like reference numerals.

### DETAILED DESCRIPTION

By way of general overview, the present invention provides a novel rigid air valve, novel installation method and novel wheel-valve assembly that overcome many of the problems associated with prior-art air valve technology.

FIG. 2 depicts a rigid air valve 20 in accordance with one embodiment of the present invention. The rigid air valve 20 is designed to be installed on a wheel 30 in order to enable inflation of a tubeless tire when the tire is mounted on the wheel. Still by way of overview, FIG. 3 shows how the rigid air valve 20 is installed in a valve hole (rim hole) of the wheel to form a wheel-valve assembly 40. FIG. 4 shows, also by way of overview, the wheel-valve assembly 40 consisting of a wheel 30 and the rigid air valve 20.

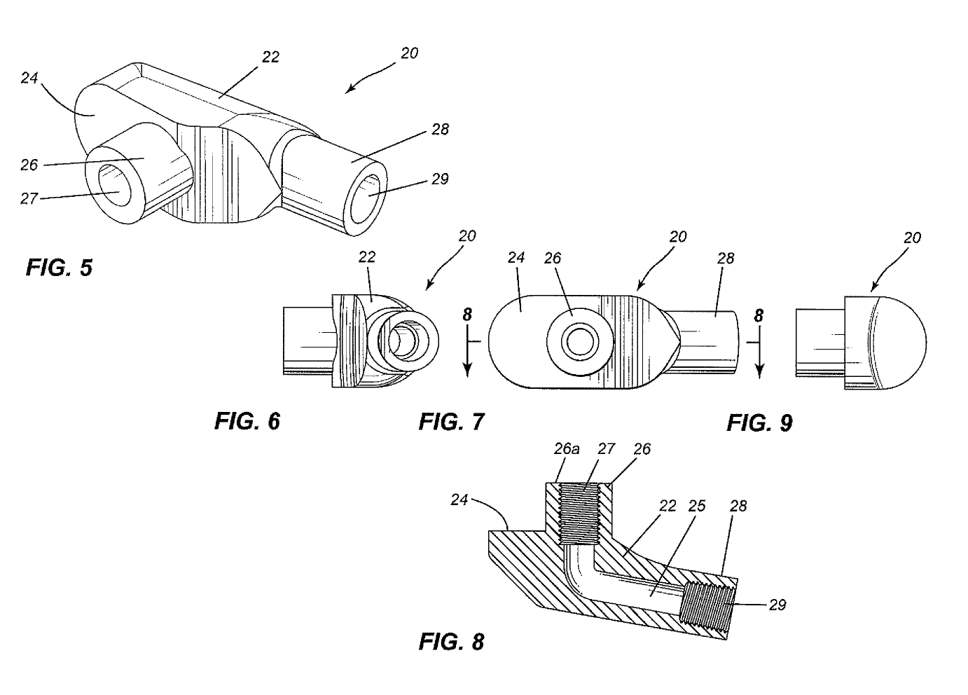

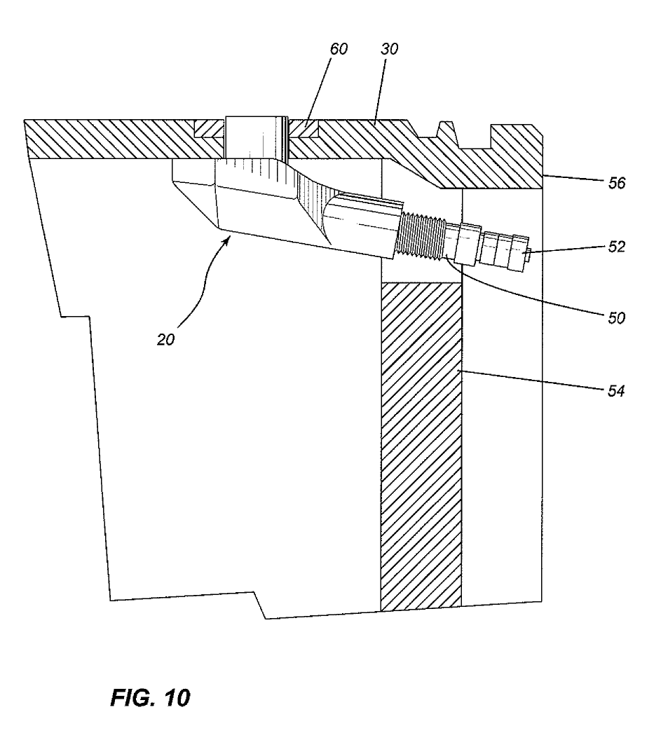

Details of the rigid air valve 20 are now described with reference to FIGS. 5-9, which show one particular embodiment of the novel rigid air valve 20. As depicted in these figures, the rigid air valve 20 comprises a valve body 22 (which may be made of steel or other suitable material). The valve body 22 includes a shoulder 24 for abutting an inner cylindrical surface of the wheel. The valve body includes a first protruding portion 26 extending radially outwardly from the shoulder 24. This first protruding portion 26 is sized to be snugly inserted into a valve hole until the shoulder 24 abuts the inner cylindrical surface of the wheel. The first protruding portion 26 extends from the inner cylindrical surface of the wheel to a tire-side outer cylindrical surface of the wheel (as depicted in FIG. 3 and in FIG. 10). The valve body 22 also includes a second protruding portion 28 extending both radially inwardly and axially outwardly through a hole in a center plate 54 and/or gutter face 56 of the wheel (as shown in FIG. 10) to thereby define a curved air passageway 25 extending from a first opening 27 in the first protruding portion 26 to a second opening 29 in the second protruding portion 28.

As depicted in FIGS. 5-9, the first protruding portion 26 and the second protruding portion 28 may be substantially cylindrical. The first protruding portion 26 may thus fit snugly into a circular valve hole.

As shown in FIG. 10, the rigid air valve 20 also includes a valve stem 50 having external threads for engaging complementary internal threads inside the second protruding portion. The valve stem 50 incorporates a valve for selectively admitting (or releasing) air into a pneumatic tire when mounted on the wheel to thus enable inflation (or deflation) of the tire. Optionally, a valve cap 52 may be affixed to the valve to prevent accidental actuation of the valve. Internal threads may also be provided inside the first protruding portion (i.e. the protrusion that is inserted into the valve hole). The valve stem may be connected using airtight pipe threads. A thread sealant may be used to ensure an airtight seal between the stem and the internal threads inside the first protruding portion.

As shown in FIG. 10, the length L of the first protruding portion measured from the shoulder 24 to the outer end 26a of the first protruding portion 26 is greater than or equal to a thickness t of the wheel.

This rigid air valve is more robust than the prior-art valves. Accordingly, the novel rigid air valve is able to sustain damage and remain operational. Damage to the valve often occurs when lifting the wheel-valve assembly to install the wheel-valve assembly on a hub. As will be noted from the drawings, the valve is built with a solid valve body that is substantially more robust than the slender elongated brass extensions found in prior-art valves. The valve body of the present invention has a substantial wall thickness surrounding the air passageway, to thus protect this air passageway from being constricted, punctured or otherwise compromised if the valve is damaged. The valve body acts as a protective shroud surrounding the air passageway. The wall thickness, it will be noted, is greatest where the air passageway curves.

As another advantage over the prior art, the novel rigid air valve provides a larger air passageway. This reduces inflation time. The air passageway comprises a first threaded section inside the first protruding portion, a second threaded section inside the second protruding portion, a curved non-threaded section connected to the first threaded section and a straight non-threaded section connected between the curved section and the second threaded section, the threaded section having a larger internal diameter than the non-threaded sections.

Another innovative aspect of this invention is the valve installation method. In general, this method entails inserting the valve body into the valve hole, tack-welding the valve body on the inner cylindrical surface of the wheel, welding the valve body on a tire-side outer cylindrical surface of the wheel by filling a counterbore 60 with weld, and grinding down the weld flush with the tire-side outer cylindrical surface of the wheel. A valve stem (having a valve) may then be connected to the valve body. A pipe thread sealant may be applied to the threads of the valve stem prior to connecting the valve stem to the valve body.

The installation method may also involve a pre-installation inspection and physical fitment test. Once the pre-installation inspection is complete, the location of the valve hole is determined. If the existing valve hole cannot be used, it is plugged with a full penetration weld and a new hole drilled using an appropriate jig. The rim may also be sandblasted and cleaned.

Prior to inserting the valve body into the valve hole, the valve body and wheel may be preheated to a minimum of 150 degrees Fahrenheit (65 degrees Celsius). The rigid air valve is then placed into the valve hole and tapped until it fits snugly and its shoulder abuts the inner diameter of the rim (inside cylindrical surface of the wheel). The second protruding portion of the valve body which connects to the valve stem must be aligned with a valve access hole in the center plate 54 or gutter face 56.

The valve body and wheel may be preheated to a minimum of 150 degrees Fahrenheit (65 degrees Celsius) prior to tack-welding. The valve may then be tack welded along each side (for example, along a length of ¾ of an inch or 1.9 cm using 0.35 wire). A bolt may be threaded into the complementary internal threads of the first protruding portion prior to welding to protect the threads during welding. The valve is then affixed to the rim by welding around the base of the valve on the tire side to fill the counterbore with weld, to thereby seal the interface of the first protruding portion and the rim hole. This may be done by first applying a fillet weld, then welding the remainder of the rim counterbore flush with the rim. The protecting bolt may then be removed. The tire side of the rim is then ground and cleaned.

The method may further comprise a subsequent step of performing a leak-test inspection of the valve, e.g. using a liquid leak-testing solution to visually inspect for air bubbles.

Even though the rigid air valve is welded to the wheel, it still can be removed and replaced, as desired. The rigid air valve is simply drilled out from the wheel and tack welds are ground off. The hole is then deburred and counterbored again. The hole and wheel rim may then be cleaned. The novel installation method described above may then be used to re-install a new or refurbished valve. This may be done multiple times although it is recommended not more than three times.

Another advantage of the rigid air valve design is that the valve stem (also known as the tank valve) may be replaced without removing the valve body from the wheel. If the valve stem (tank valve) is ever damaged in operation, it can simply be unscrewed from the valve body and replaced with a new one.

This invention has been described in terms of specific examples, embodiments, implementations and configurations which are intended to be exemplary only. Persons of ordinary skill in the art will appreciate that obvious variations, modifications and refinements will become apparent from the present disclosure and that these can be made without departing from the scope of the present invention. The scope of the exclusive right sought by the Applicant is therefore intended to be limited solely by the appended claims.

1. A rigid air valve for use with a wheel, the valve comprising:
a valve body having:
a shoulder for abutting an inner cylindrical surface of the wheel;
a first protruding portion extending radially outwardly from the shoulder and sized to be snugly inserted into a valve hole until the shoulder abuts the inner cylindrical surface of the wheel, the first protruding portion extending from the inner cylindrical surface of the wheel to a tire-side outer cylindrical surface of the wheel;
a second protruding portion extending both radially inwardly and axially outwardly through a hole in a center plate of the wheel to thereby define a curved air passageway extending from a first opening in the first protruding portion to a second opening in the second protruding portion; and
a valve stem having external threads for engaging complementary internal threads inside the second protruding portion, the valve stem including a valve for selectively admitting air into a pneumatic tire when mounted on the wheel.

2. The valve as claimed in claim 1 wherein the first protruding portion also comprises internal threads.

3. The valve as claimed in claim 1 wherein the first protruding portion and the second protruding portion are substantially cylindrical, the first protruding portion being dimensioned to fit snugly into a circular valve hole.

4. The valve as claimed in claim 1 wherein a length of the first protruding portion measured from the shoulder to the outer end of the first protruding portion is greater than or equal to a thickness of the wheel.

5. The valve as claimed in claim 1 wherein a wall thickness of the valve body surrounding the air passageway is greatest where the air passageway curves.

6. The valve as claimed in claim 5 wherein the air passageway comprises a first threaded section inside the first protruding portion, a second threaded section inside the second protruding portion, a curved non-threaded section connected to the first threaded section and a straight non-threaded section connected between the curved section and the second threaded section, the threaded section having a larger internal diameter than the non-threaded sections.

7. The valve as claimed in claim 1 wherein the first protruding section has airtight pipe threads.

8. A method for installing a valve on a wheel, the method comprising:
inserting the valve body into the valve hole;
tack-welding the valve body on the inner cylindrical surface of the wheel;
welding the valve body on a tire-side outer cylindrical surface of the wheel by filling a counterbore with weld;
grinding the weld flush with the tire-side outer cylindrical surface of the wheel; and
connecting a valve stem having a valve to the valve body.

9. The method as claimed in claim 8 further comprising applying a pipe thread sealant to external threads of the valve stem prior to connecting the valve stem to the valve body.

10. The method as claimed in claim 9 further comprising a subsequent step of performing a leak-test inspection of the valve.

11. The method as claimed in claim 8 wherein the valve body and wheel are preheated to a minimum of 150 degrees Fahrenheit (65 degrees Celsius) prior to inserting the valve body into the valve hole.

12. The method as claimed in claim 8 wherein the valve body and wheel are preheated to a minimum of 150 degrees Fahrenheit (65 degrees Celsius) prior to tack-welding.

13. The method as claimed in claim 8 further comprising threading a bolt into the complementary internal threads of the first protruding portion prior to welding.

14. A wheel-valve assembly comprising:
a wheel adapted for receiving a tubeless tire; and
a rigid air valve comprising:
a valve body having:
a shoulder for abutting an inner cylindrical surface of the wheel;
a first protruding portion extending radially outwardly from the shoulder and sized to be snugly inserted into a valve hole until the shoulder abuts the inner cylindrical surface of the wheel, the first protruding portion extending from the inner cylindrical surface of the wheel to a tire-side outer cylindrical surface of the wheel;
a second protruding portion extending both radially inwardly and axially outwardly through a hole in a center plate of the wheel to thereby define a curved air passageway extending from a first opening in the first protruding portion to a second opening in the second protruding portion; and
a valve stem having external threads for engaging complementary internal threads formed in the second opening, the valve stem including a valve for selectively admitting air into a pneumatic tire when mounted on the wheel.

15. The wheel-valve assembly as claimed in claim 14 wherein the first protruding portion has a first threaded section, the second protruding portion has a second threaded section, and wherein the air passageway further comprises:
a curved non-threaded section connected to the first threaded section, and
a straight non-threaded section connected between the curved section and the second threaded section,
wherein the non-threaded sections have a smaller cross-sectional area than the threaded sections.
